(19) United States
(12) Patent Application Publication
(10) Pub. No.: US 2008/0023650 A1
(43) Pub. Date: Jan. 31, 2008

(54) RADIATION IMAGE CONVERSION PANEL AND PROCESS FOR PRODUCING THE SAME

(75) Inventors: Yuji ISODA, Ashigara-kami-gun (JP); Keiichiro SATO, Ashigara-kami-gun (JP); Yasuo IWABUCHI, Ashigara-kami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/829,404

(22) Filed: Jul. 27, 2007

(30) Foreign Application Priority Data
Jul. 27, 2006 (JP) 2006-204456

(51) Int. Cl. H05B 33/00

(52) U.S. Cl. 250/484.4

(57) ABSTRACT

A radiation image conversion panel includes a substrate, a phosphor layer formed on the substrate by vapor-phase deposition, and a protective layer covering entirely the phosphor layer to hermetically seal it. A color at a surface of the panel on which exciting light is incident has a density of 0.001 to 0.095 and the color is a color corresponding to a wavelength of 440 nm. A process for producing the panel forms the phosphor layer on the substrate by the vapor-phase deposition and subjects the phosphor layer to a thermal treatment. The process may subject as the thermal treatment the phosphor layer to one or more cycles of a first thermal treatment for heating and cooling it and to only one cycle of a second thermal treatment for heating it in a presence of oxygen. The process further subjects the phosphor layer to humidification which is a treatment for making it absorb moisture.

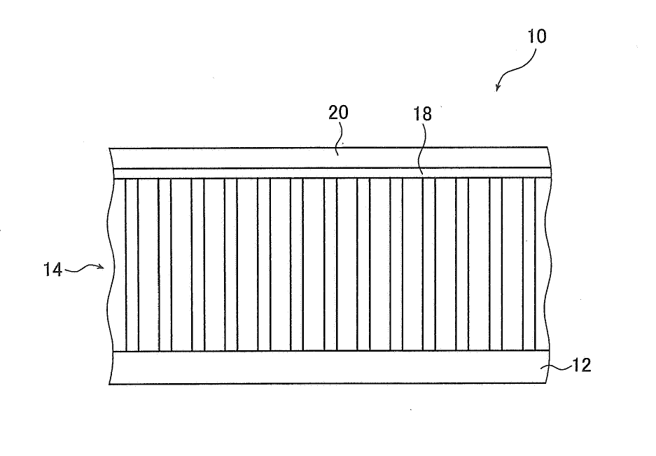

The entire contents of documents cited in this specification are incorporated herein by reference.

### BACKGROUND OF THE INVENTION

The present invention belongs to a technical field of a radiation image conversion panel that may be used in X-ray photography. More specifically, the invention relates to a radiation image conversion panel that is excellent in photostimulated luminescence (hereinafter sometimes abbreviated as “PSL”) characteristics such as PSL sensitivity, and a process suitable for producing the radiation image conversion panel.

Upon exposure to a radiation (e.g. X-rays, α-rays, β-rays, γ-rays, electron beams, and ultraviolet rays), certain types of phosphors known in the art accumulate part of the energy of the applied radiation and, in response to subsequent application of exciting light such as visible light, they emit photostimulated luminescence in an amount that is associated with the accumulated energy. Called “storage phosphors” or “stimulable phosphors”, those types of phosphors find use in medical and various other fields.

A known example of such use is a radiation image information recording and reproducing system that employs a radiation image conversion panel having a film (or layer) of the stimulable phosphor (which is hereinafter referred to as a “phosphor layer”). The radiation image conversion panel is hereinafter referred to simply as the “conversion panel” and is also called the stimulable (storage) phosphor panel (sheet). The system has already been commercialized by, for example, FUJIFILM Corporation under the trade name of FCR (Fuji Computed Radiography).

In that system, a subject such as a human body is irradiated with X-rays or the like to record a radiation image about the subject on the conversion panel (more specifically, the phosphor layer). After the radiation image is thus recorded, the conversion panel is scanned two-dimensionally with exciting light to emit photostimulated luminescence which, in turn, is read photoelectrically to yield an image signal. Then, an image reproduced on the basis of the image signal is output as the radiation image of the subject, typically to a display device such as a CRT (cathode ray tube) display or on a recording material such as a photosensitive material.

The conversion panel is typically prepared by the following method: Powder of a stimulable phosphor is dispersed in a solvent containing a binder and other necessary ingredients to make a coating solution, which is applied to a panel-shaped support made of glass or a resin, with the applied coating being subsequently dried.

As described in JP 2002-350597 A, JP 2003-232895 A, JP 2003-279696 A and JP 2006-90853 A to be referred to below, also known are conversion panels which are prepared by forming a phosphor layer on a substrate through vapor-phase deposition techniques (vacuum film deposition techniques) such as vacuum evaporation or sputtering. The phosphor layer formed by such vapor-phase deposition has superior characteristics in that it is formed in vacuo and hence has low impurity levels and that being substantially free of any ingredients other than the stimulable phosphor as exemplified by a binder, the phosphor layer not only has small scatter in performance but also features very highly efficient luminescence.

Conversion panels require various characteristics including excellent sharpness (an image reproduced with a high sharpness is obtained) and high sensitivity. Various studies have been made to fulfill the requirements for the characteristics of the above-mentioned conversion panels each having the phosphor layer formed by vapor-phase deposition.

To be more specific, JP 2002-350597 A discloses a conversion panel that has a phosphor layer formed by vapor-phase deposition and in which high sharpness is achieved by having a phosphor layer thickness of at least 50 μm and setting the transmittance or reflectance of exciting light with a wavelength of 680 nm incident on the phosphor layer to at least 20%. JP 2003-232895 A discloses that it is preferable to set the reflectance from a phosphor layer to at least 20% and particularly at least 40% in order to obtain photostimulated luminescence with high luminance, that is, a highly sensitive conversion panel.

JP 2003-279696 A discloses a highly sensitive conversion panel having a phosphor layer with an increased amount of photostimulated luminescence that is obtained by forming the phosphor layer by vapor-phase deposition, then subjecting the thus formed phosphor layer to a thermal treatment at 50 to 300° C. for 1 to 8 hours in an inert atmosphere or an atmosphere containing a small amount of oxygen or hydrogen.

In addition, JP 2006-90853 A discloses a conversion panel that ensures improved sharpness and increased photostimulated luminescence amount (i.e., improved sensitivity) and which is obtained by forming a phosphor layer by vapor-phase deposition, humidifying the phosphor layer in an environment of a relative humidity of 30 to 60% RH and heating the humidified phosphor layer at 60 to 160° C. to dehydrate.

### SUMMARY OF THE INVENTION

The conversion panels disclosed in those documents feature excellent photostimulated luminescence characteristics and sharpness.

However, the requirements for the characteristics of conversion panels and particularly for their sensitivity have become stricter than ever before and it is desired to produce conversion panels having more excellent characteristics.

An object of the present invention is to solve the conventional problems as described above by providing a radiation image conversion panel that includes a stimulable phosphor layer with a properly white surface as formed by vapor-phase deposition and which achieves high reflectance for photostimulated luminescence and high sensitivity.

Another object of the present invention is to provide a process for producing the radiation image conversion panel.

In order to achieve the above objects, the present invention provides a radiation image conversion panel comprising: a substrate; a phosphor layer which is formed on the substrate by vapor-phase deposition; and a protective layer which entirely covers the phosphor layer to hermetically seal the phosphor layer, wherein a color at a surface of the radiation image conversion panel on which exciting light is incident has a density of 0.001 to 0.095, and the color is a color corresponding to a wavelength of 440 nm.

The phosphor layer preferably comprises columnar crystals.

The phosphor layer preferably comprises a stimulable phosphor represented by general formula “CsBr:Eu”.

The protective layer preferably includes: a polyethylene terephthalate film; a first SiO₂ sub-layer formed on the polyethylene terephthalate film; a hybrid sub-layer of SiO₂ and polyvinyl alcohol formed on the first SiO₂ sub-layer; and a second SiO₂ sub-layer formed on the hybrid sub-layer.

The present invention also provides a process for producing a radiation image conversion panel comprising the steps of: forming a phosphor layer on a surface of a substrate by vapor-phase deposition subjecting the phosphor layer to one or more cycles of a first thermal treatment which comprises heating the phosphor layer under predetermined conditions and cooling the heated phosphor layer; and subjecting the phosphor layer having undergone the one or more cycles of the first thermal treatment to only one cycle of a second thermal treatment which comprises heating the phosphor layer in a presence of oxygen for 5 to 180 minutes at a temperature that is equal to or higher than an ultimate temperature of the phosphor layer in subsequent steps and falls within a range of 150 to 250° C.

Preferably, the process further comprises a step of performing humidification for making the phosphor layer absorb moisture on the phosphor layer prior to at least one cycle of the one or more cycles of the first thermal treatment.

The humidification is preferably a treatment for making the phosphor layer absorb the moisture such that the phosphor layer after the humidification has a weight of 100.02 to 100.85 relative to a weight of the phosphor layer before the humidification taken as 100.

Preferably, the humidification for making the phosphor layer absorb the moisture is further performed after the first thermal treatment and prior to the second thermal treatment.

Preferably, the process further comprises a step of covering entirely the phosphor layer with a protective layer to hermetically seal the phosphor layer after the second thermal treatment.

The present invention further provides a process for producing a radiation image conversion panel comprising the steps of: forming a phosphor layer on a surface of a substrate by vapor-phase deposition; subjecting the phosphor layer to humidification which is a treatment for making the phosphor layer absorb moisture such that the phosphor layer after the humidification has a weight of 100.02 to 100.85 relative to a weight of the phosphor layer before the humidification taken as 100; and subjecting the phosphor layer to a thermal treatment for heating the phosphor layer.

The humidification is preferably a treatment to expose the phosphor layer for 0.5 to 168 hours to an environment of a temperature of 10 to 60° C. and a relative humidity of 20 to 45% RH.

The humidification is preferably a treatment to expose the phosphor layer for a predetermined period of time to an environment of a temperature T of 10 to 60° C. and a relative humidity H satisfying “45% RH<H≦80% RH” so that “X” represented by formula:

X=exp(6.4×10⁻²×(T+273))×H×10⁻¹⁰×t

(where t (h) is a treatment time) takes a value of 0.2 to 210.

The humidification is preferably a treatment to expose the phosphor layer for 10 to 30 minutes to an environment of a temperature of 10 to 60° C. and a relative humidity in excess of 80% RH but less than 90% RH.

Preferably, the process further comprises a step of covering entirely the phosphor layer with a protective layer to hermetically seal the phosphor layer after the thermal treatment.

The radiation image conversion panel having the features described above according to the present invention has less coloration due to an element liberated from a phosphor constituting the phosphor layers. Therefore, the phosphor layer hardly absorbs photostimulated luminescence, thus offering significantly high sensitivity to PSL (emitting a large amount of PSL).

The radiation image conversion panel production process of the present invention in which the phosphor layer having been formed by a vapor-phase deposition technique such as vacuum evaporation is subjected to one or more cycles of the first thermal treatment, then the second thermal treatment in the presence of oxygen is performed as the final thermal treatment, or a predetermined humidification process for humidifying the phosphor layer is followed by the thermal treatment of the phosphor layer, can suppress coloration due to an element liberated from a phosphor constituting the phosphor layer while improving the sensitivity as well. Therefore, the production process of the present invention enables a highly sensitive radiation image conversion panel to be produced by the synergistic effect of the reflectance and sensitivity improved by the properly white phosphor layer.

### BRIEF DESCRIPTION OF THE DRAWINGS

The FIGURE is a schematic diagram of an embodiment of a radiation image conversion panel of the present invention.

### DETAILED DESCRIPTION OF THE PREFERRED EMBODIMENTS

On the pages that follow, the radiation image conversion panel and the process for producing the radiation image conversion panel according to the present invention are described in detail with reference to the preferred embodiments depicted in the accompanying drawing.

The FIGURE shows in concept an exemplary radiation image conversion panel of the present invention.

A radiation image conversion panel of the present invention which is generally indicated by 10 (hereinafter referred to as a “conversion panel 10”) comprises a substrate 12, a phosphor layer 14, and a protective layer 20 entirely covering the phosphor layer 14 to hermetically seal it with the substrate 12 and the protective layer 20. In the illustrated preferred embodiment, the substrate 12 on the periphery of the phosphor layer 14 is not only adhered to the protective layer 20 via an adhesive layer 18 to hermetically seal the phosphor layer 14 with the protective layer 20 and the substrate 12 but also the phosphor layer 14 is adhered to the protective layer 20 via the adhesive layer 18.

There is no particular limitation on the structure of the radiation image conversion panel of the present invention as long as the color corresponding to a wavelength of 440 nm at the plane of incidence of exciting light, that is, at the surface of the radiation image conversion panel on which exciting light is incident, specifically, at the surface of the protective layer 20 (the surface of the protective layer 20 opposite from the substrate 12) in the illustrated case has a density of 0.001 to 0.095.

For example, the adhesive layer 18 and the protective layer 20 may be omitted if the phosphor layer 14 has adequate moisture resistance. Instead of adhering the protective layer 20 to the phosphor layer 14 with the adhesive layer 18, the protective layer 20 may only be adhered to the substrate 12 (or a frame member to be described later) with the adhesive layer 18 such that the phosphor layer 14 may be covered and sealed with the protective layer 20.

There is no particular limitation on the substrate 12 of the conversion panel 10 of the present invention but various types as used in conventionally known radiation image conversion panels are usable.

Exemplary types include plastic plates and sheets (films) made of, for example, cellulose acetate, polyester, polyethylene terephthalate, polyamide, polyimide, triacetate, and polycarbonate; glass plates and sheets made of, for example, quartz glass, alkali-free glassy soda glass, and heat-resistant glass (e.g., Pyrex™); metal plates and sheets made of metals such as aluminum, iron, copper and chromium; and plates and sheets obtained by forming a coating layer such as a metal oxide layer on the surfaces of such metal plates and sheets.

If desired, the substrate 12 may have on its surface a protective layer (protective layer for protecting the base body of the substrate 12), a reflective layer that reflects photostimulated luminescence, and even a protective layer that protects the reflective layer. In this case, the phosphor layer 14 is formed on top of these layers.

In the present invention, the phosphor layer 14 is formed by a vapor-phase deposition technique such as vacuum evaporation. In a preferred embodiment, the illustrated conversion panel 10 has a columnar crystal structure made up of columnar crystals isolated from each other.

In the conversion panel 10 shown in the FIGURE, the columnar crystals grow from the surface of the substrate 12. However, this is not the sole case of the present invention.

To be more specific, there are many cases where, in a phosphor layer formed by vacuum evaporation, particularly the one comprising a stimulable phosphor and in particular an alkali halide-based stimulable phosphor to be described later, crystals initially grow in a spherical shape and further grow in a columnar shape to form columnar crystals according to the conditions under which the phosphor layer 14 is formed (conditions of film deposition) In such a case, the conversion panel 10 of the present invention may have a structure in which a spherical crystal layer having aggregated spherical crystals is formed on the surface of the substrate 12 and a columnar crystal layer is formed thereon.

In the case where crystals grow in a spherical shape as described above, depending on the forming conditions of the phosphor layer 14, the spherical crystals very often stick to each other across the surface of the substrate 12 to form aggregates (domains) before columnar crystals grow, and the columnar crystals are then formed from the domains. In such a case, the conversion panel 10 of the present invention may be of a structure in which a columnar crystal layer is formed on a domain layer having the domains, which is formed on a spherical crystal layer having aggregated spherical crystals, which in turn is formed on the surface of the substrate 12.

In the present invention, the phosphor layer 14 is formed by vapor-phase deposition techniques such as vacuum evaporation and CVD (chemical vapor deposition). Vacuum evaporation is a particularly preferred method for forming the phosphor layer 14 because the effects of the present invention are readily achieved.

There is also no particular limitation on the form of the phosphor layer 14 but, as schematically shown in the FIGURE, the phosphor layer 14 is preferably made up of a phosphor of discrete columnar crystals. Formation of the phosphor layer 14 having such columnar phosphor crystals enables the conversion panel 10 obtained to be highly sensitive and contribute to more enhanced sharpness (a radiation image with high sharpness can be reproduced).

There is also no particular limitation on the phosphor used to form the phosphor layer 14, but various known phosphors as used in radiation image conversion panels may be used.

In terms of readily achieving the effects of the present invention, stimulable phosphors containing a phosphor and an activator are advantageous, with alkali halide-based stimulable phosphors represented by the general formula “M^{I}X·aM^{II}X′₂·bM^{III}X″₃:cA” as disclosed in JP 61-72087 A being more advantageously used. In this formula, M^{I} represents at least one element selected from the group consisting of Li, Na, K, Rb, and Cs. M^{II} represents at least one divalent metal selected from the group consisting of Be, Mg, Ca, Sr, Ba, Zn, Cd, Cu, and Ni. M^{III} represents at least one trivalent metal selected from the group consisting of Sc, Y, La, Ce, Pr, Nd, Pm, Sm, Eu, Gd, Tb, Dy, Ho, Er, Tm, Yb, Lu, Al, Ga, and In. X, X′, and X″ each represent at least one element selected from the group consisting of F, Cl, Br, and I. A represents at least one element selected from the group consisting of Eu, Tb, Ce, Tm, Dy, Pr, Ho, Nd, Yb, Er, Gd, Lu, Sm, Y, Tl, Na, Ag, Cu, Bi, and Mg, 0≦a<0.5, 0≦b<0.5, and 0≦c≦0.2.

Of these, an alkali halide-based stimulable phosphor in which M^{I} contains at least Cs, X contains at least Br, and A is Eu or Bi is preferred, and a stimulable phosphor represented by the general formula “CsBr:Eu” is more preferred because they have excellent photostimulated luminescence characteristics and the effects of the present invention are advantageously achieved.

Various other stimulable phosphors disclosed in, for example, U.S. Pat. No. 3,859,527, JP 55-12142 A, JP 55-12144 A, JP 55-12145 A, JP 56-116777 A, JP 58-69281 A, JP 58-206678 A, and JP 59-38278 A and JP 59-75200 A may also be advantageously used.

The conversion panel 10 having the phosphor layer of a stimulable phosphor is not the sole case of the present invention, but the present invention may be advantageously used in various radiation image conversion panels having a phosphor layer, such as a radiation scintillator panel having a phosphor layer comprising a phosphor such as cesium iodide.

The conversion panel 10 of the present invention has no particular limitation on the thickness of the phosphor layer 14 and it is preferably between 100 μm and 1500 μm, with the range of 500-1000 μm being particularly.preferred Adjusting the thickness of the phosphor layer 14 to lie within those ranges is preferred from various viewpoints including the image sharpness.

In the case where the phosphor layer 14 in the conversion panel 10 of the present invention is made up of a stimulable phosphor including a phosphor and an activator, the stimulable phosphor may be used to form the whole of the phosphor layer 14. However, it is preferable to form in its lower part a matrix region that contains substantially no activator and form thereon a region of a stimulable phosphor containing an activator. For example, in the case where the stimulable phosphor is CsBr:Eu that contains Eu as an activator, the matrix region is substantially formed of only CsBr, whereas the stimulable phosphor region is formed of CsBr:Eu. The expression “contains substantially no activator” means that the content of an activator is up to 1.0×10⁻⁶ ppm and preferably no activator is completely contained.

The matrix region acts as the stress relaxing layer, so the above-mentioned structure enables the adhesion between the phosphor layer 14 and the substrate 12 to be more enhanced.

The illustrated conversion panel 10 has the protective layer 20 that covers the entire surface of the phosphor layer 14 to hermetically seal it.

The phosphor layer formed by vapor-phase deposition, and particularly the phosphor layer of the alkali halide-based stimulable phosphor are highly hygroscopic and will readily deteriorate upon absorption of moisture.

Therefore, in order to prevent the moisture absorption of the phosphor layer 14, it is preferable that, as shown in the FIGURE, the conversion panel 10 produced in the present invention be provided with the protective layer 20 that has moisture resistance (water impermeability) and entirely covers the phosphor layer 14 to hermetically seal it.

Various types of material may be used for the protective layer 20 without any particular limitation as long as the material has sufficient moisture resistance, is transparent and colorless, and fully transmits photostimulated luminescence and exciting light.

Fox example, the protective layer 20 is formed of 3 sub-layers on a polyethylene terephthalate (PET) film: an SiO₂ sub-layer; a hybrid sub-layer of SiO₂ and polyvinyl alcohol (PVA); and an SiO₂ sub-layer. For formation of the protective layer 20 having 3 sub-layers of SiO₂ sub-layer/hybrid sub-layer of SiO₂ and PVA/SiO₂ sub-layer on the PET film, the SiO₂ sub-layers may be formed through sputtering and the hybrid sub-layer of SiO₂ and PVA may be formed through a sol-gel process, for example. The hybrid sub-layer is preferably formed to have a ratio of PVA to SiO₂ of 1:1.

Other examples of the material that may be preferably used for the protective layer 20 include a glass plate (film); a film of resin such as polyethylene terephthalate or polycarbonate; and a film having an inorganic substance such as SiO₂, Al₂O₃, or SiC deposited on the resin film.

To construct the conversion panel 10 of the present invention, the phosphor layer 14 is entirely covered with the protective layer 20 that surrounds the entire circumference of the phosphor layer 14 and the adhesive layer 18 is applied to adhere the protective layer 20 to the substrate 12 so that the phosphor layer 14 is entirely covered with the protective layer 20 and sealed with the protective layer 20 and the substrate 12.

However, in a more preferred embodiment, the adhesive layer 18 is applied not only between the substrate 12 and the protective layer 20 but also to the surface of the phosphor layer 14 as shown in the FIGURE, so that the protective layer 20 is also adhered to the phosphor layer 14. This structural design helps prevent such problems as the floating of the protective layer 20, thus providing a highly durable conversion panel 10 that features even better mechanical strength.

The adhesive layer 18 for the protective layer 20 is not limited in any particular way and various types may be employed as long as they have sufficient adhesive powers. However, if the adhesive layer 18 is to be additionally provided on the surface of the phosphor layer 14 as shown in the FIGURE, it must be transparent and colorless, and have such optical characteristics as to permit sufficient transmission of photostimulated luminescence and exciting light.

In the conversion panel 10 of the present invention, the color corresponding to a wavelength of 440 nm at the plane of incidence of exciting light has a density of 0.001 to 0.095.

The density of the color corresponding to a wavelength of 440 nm at the plane of incidence of exciting light refers to a reflection density on the incidence plane side of the exiting light in the case where the substrate 12 is optically reflective and a transmission density from the incidence plane side of the exiting light in the case where the substrate 12 is optically transparent. The reflection density may be determined by measuring the reflectance at 440 nm with, for example, a general-purpose spectrophotometer and substituting the thus measured reflectance into the Kubelka-Munk equation. On the other hand, the transmission density may be calculated as the common logarithm of the reciprocal of the transmittance at 440 nm measured with, for example, a general-purpose spectrophotometer.

The wavelength of 440 nm brings about yellow color, so the density of the color corresponding to the wavelength of 440 nm will be hereinafter referred to as the “yellow density” for the sake of convenience.

It is necessary to reduce absorption of luminescence in the phosphor layer 14 of the conversion panel 10 in order to obtain a large amount of luminescence from irradiation with exciting light.

It is known to improve the reflectance from the phosphor layer surface in order to achieve the above object. For example, JP 2003-232895 A discloses that it is preferable to set the reflectance or transmittance to at least 20% and particularly at least 40% in order to obtain photostimulated luminescence with high luminance. JP 2002-350597 A discloses that the phosphor layer having a reflectance or transmittance of at least 20% and particularly at least 40% achieves high sharpness.

However, there is a limit to the improvement of the reflectance from the phosphor layer surface and the reflectance from the plane of incidence of exciting light is further reduced because the conversion panel 10 has the protective layer 20 for protecting the phosphor layer against moisture.

The inventors of the present invention have made intensive studies to realize a conversion panel having a higher sensitivity to PSL (emitting a larger amount of PSL) and found that yellow coloration of the phosphor layer due to an element liberated from a phosphor contributes to reduced luminescence intensity, in other words, reduced sensitivity of the conversion panel.

In a stimulable phosphor formed by vapor-phase deposition, particularly any of the above-mentioned alkali halide-based stimulable phosphor and more particularly the stimulable phosphor represented by the general formula “CsBr:Eu”, heating to 100° C. or higher liberates a certain element from the phosphor and the thus liberated element causes the phosphor layer 14 to turn yellow although the density is extremely low. In the case of CsBr:Eu, for example, heating of the phosphor liberates bromine, resulting in yellow coloration of the phosphor layer 14. Yellow coloration may also occur by the reaction of the protective layer 20 and the adhesive layer 18 with the liberated element.

Even if the density is extremely low, the coloration of the phosphor layer may lead to reduced luminescence intensity in other words, reduced sensitivity.

The present invention has been made based on such finding, and a highly sensitive conversion panel that has a white phosphor layer causing no coloration due to a liberated element is realized by setting the yellow density at the plane of incidence of exciting light in a range of 0.001 to 0.095.

The conversion panel 10 of the present invention preferably has a lower yellow density, but it is impossible to completely avoid liberation of an element that may be caused by heating. Reducing the yellow density to less than 0.001 is very disadvantageous from various viewpoints including the cost and productivity of the conversion panel and is therefore impractical. In the case where the conversion panel 10 has the phosphor layer 14 made up of a stimulable phosphor such as the CsBr:Eu in which the matrix (phosphor) is activated by an activator, it is basically impossible to avoid liberation of an element caused by heating, and reducing the yellow density to less than 0.001 requires considerable reduction of the amount of activator used. However, reduction of the amount of activator to such a level that the yellow density reaches less than 0.001 may compromise the other characteristics such as sensitivity and cause practical problems and is therefore impractical. Although it is not clear why inclusion of an activator increases the amount of element liberation, a halogen element near the activator would be readily liberated for some reasons as a gaseous halogen during the thermal treatment.

On the other hand, at a yellow density in excess of 0.095, absorption of the luminescence in the phosphor layer 14 due to coloration is increased too much to obtain a highly sensitive conversion panel.

In the present invention, it is particularly preferable for the yellow density at the plane of incidence of exciting light to lie within the range of 0.001 to 0.05.

In the conversion panel of the present invention, the reflectance from the plane of incidence of exciting light is not particularly limited, and the reflectance from the plane of incidence of exciting light in terms of photostimulated luminescence at the peak position (peak wavelength) is preferably 60 to 95% and more preferably 70 to 95%.

The reflectance from the plane of incidence of exciting light falling within such range enables the conversion panel 10 obtained to be more sensitive and is therefore preferable.

The radiation image conversion panel production process of the present invention that may be used to produce the conversion panel 10 of the present invention is described below.

First, the phosphor layer 14 is formed on a surface of the substrate 12 by vapor-phase deposition.

In the present invention, plasma cleaning is preferably performed prior to forming the phosphor layer 14 to clean the surface of the substrate 12 and make it hydrophilic. The surface of the substrate 12 may be cleaned with an organic solvent such as acetone prior to the plasma cleaning. In addition, it is also preferable to remove dust from the surface of the substrate 12 by ionic wind or a sticky roller just before forming the phosphor layer 14.

In the conversion panel 10 of the present invention, the phosphor layer 14 is formed by various vapor-phase deposition techniques (vacuum film deposition techniques) including vacuum evaporation, sputtering, and CVD (chemical vapor deposition).

Among these techniques, vacuum evaporation is a preferred method for forming the phosphor layer 14 from various viewpoints such as productivity.

In the case of using a stimulable phosphor, it is preferred to form the phosphor layer 14 by two-source (multi-source) vacuum evaporation in which two film-forming materials, one for the phosphor and the other for the activator, are independently heated to evaporate.

In the case of using CsBr:Eu as the stimulable phosphor, it is preferred to perform two-source vacuum evaporation which uses cesium bromide (CsBr) as the film-forming material for the phosphor and europium bromide (EuBrₓ; x is usually from 2 to 3, with 2 being preferred) as the film-forming material for the activator, respectively.

When the phosphor layer 14 is formed by vacuum evaporation, there is no particular limitation on the heating method that can be employed in vacuum evaporation and the phosphor layer may be formed by electron beam heating using an electron gun or the like, or by resistance heating. If the phosphor layer is to be formed by multi-source vacuum evaporation, all film-forming materials may be heated to evaporate by the same heating means (such as electron beam heating). Alternatively, the film-forming material for the phosphor may be heated to evaporate by electron beam heating while the film-forming material for the activator, which is present in a very small amount, may be heated to evaporate by resistance heating.

There is also no particular limitation on the conditions (of film deposition) under which the phosphor layer 14 is to be formed and they may be determined as appropriate for the type of the vapor-phase deposition method used, the film-forming materials used, the heating means, and other factors.

The conversion panel 10 of the present invention is further described below. If the phosphor layer 14 including any one of the afore-mentioned various stimulable phosphors, particularly an alkali halide-based stimulable phosphor, more particularly a stimulable phosphor represented by the general formula “CsX:Eu” where X is a halogen, and most particularly CsBr:Eu is to be formed by vacuum evaporation, a preferred procedure comprises first evacuating a system to a high degree of vacuum, then introducing an argon gas, a nitrogen gas or the like into the system to achieve a degree of vacuum between about 0.01 Pa and 3 Pa (which is hereinafter referred to as “medium degree of vacuum” for the sake of convenience), and heating the film-forming materials by resistance heating or the like to perform vacuum evaporation under such medium degree of vacuum.

As already mentioned, the phosphor layer 14 having discrete columnar crystals are formed by vapor-phase deposition. The phosphor layer 14 that is formed by performing film deposition under the medium degree of vacuum, in particular, the phosphor layer 14 of an alkali halide-based stimulable phosphor such as CsBr:Eu has an especially satisfactory columnar crystal structure and is preferred in such terms as the PSL characteristics and the sharpness of the image that can be produced.

In the production process of the present invention, the phosphor layer 14 is formed as described above, after which a thermal treatment (annealing) to heat the phosphor layer 14 is performed to improve the PSL characteristics, thereafter the phosphor layer 14 is entirely sealed with the protective layer 20 as described above.

The surface of the phosphor layer 14 may optionally be polished prior to the thermal treatment (or during the thermal treatment performed a plurality of times).

In a first embodiment of the production process of the present invention, the thermal treatment involves a first thermal treatment that is repeatedly performed under arbitrary conditions a predetermined number of times which may be once or more, and a second thermal treatment that is performed only once under predetermined conditions. After the thermal treatment, the phosphor layer 14 is sealed with the protective layer 20.

In a second embodiment of the production process of the present invention, humidification which is a treatment to make the phosphor layer 14 absorb moisture is followed by the thermal treatment, which in turn is followed by sealing of the phosphor layer 14 with the protective layer 20.

The production process of the present invention that includes the thermal treatment which is performed a plurality of times or follows humidification enables improvement of the sensitivity of the phosphor layer 14 and removal of an element liberated from a phosphor which remains in the phosphor layer 14 to thereby significantly reduce coloration of the phosphor layer owing to the liberated element.

As described above, heating a phosphor to 100° C. or higher liberates an element and the thus liberated element causes coloration of the phosphor layer, which may reduce the sensitivity of the conversion panel 10.

The phosphor layer 14 is heated to 100° C. or higher in the step of forming the phosphor layer 14 and the thermal treatment step. When a thermoplastic resin is used for the adhesive layer 18, the phosphor layer 14 is preferably sealed with the protective layer 20 by thermocompression bonding (heat lamination). In this case, the phosphor layer 14 may be heated to 100° C. or higher.

In the step of forming the phosphor layer 14 and the thermal treatment step, part of the liberated element dissipate from the phosphor layer 14 with time, but the other part of the liberated element adheres to columnar crystals, thus remaining in the phosphor layer 14. After the phosphor layer 14 has been sealed with the protective layer 20, the liberated element does not dissipate but remains in the phosphor layer causing its coloration. Yellow coloration may also occur by the reaction of the protective layer 20 or the adhesive layer 18 with such liberated element.

Therefore, in order to produce the inventive conversion panel 10 having a yellow density (density of the color corresponding to a wavelength of 440 nm) of 0.001 to 0.095, it is preferable to remove such liberated element as much as possible prior to the sealing step for sealing the phosphor layer 14 with the protective layer 20.

In the first embodiment of the production process of the present invention, the thermal treatment is followed by sealing of the phosphor layer 14 with the protective layer 20. The thermal treatment includes the first thermal treatment to heat the phosphor layer 14 under arbitrary conditions which is performed a predetermined number of times including once or more, and the second thermal treatment to heat the phosphor layer which follows the first thermal treatment and is performed only once in the presence of oxygen for 5 to 180 minutes at a temperature that is equal to or higher than the ultimate temperature of the phosphor layer in the subsequent steps and falls within the range of 150 to 250° C.

The phosphor layer is usually heat-treated only once in the manufacture of the radiation image conversion panel. In this embodiment, however, the phosphor layer is heat-treated a plurality of times (repeatedly heat-treated) to improve the sensitivity of the phosphor layer, whereas the second thermal treatment (corresponding to the final cycle of the repeatedly performed thermal treatment) is performed in the presence of oxygen under predetermined conditions to remove a liberated element such as bromine to prevent coloration of the phosphor layer 14.

The first thermal treatment may be performed under any appropriately set conditions. Therefore, the first thermal treatment may be performed in an inert atmosphere such as a nitrogen atmosphere or in an oxygen-containing atmosphere. There is also no particular limitation on the temperature and time of the thermal treatment. The first thermal treatment is preferably performed in an inert atmosphere such as a nitrogen atmosphere or in the presence of a small amount of oxygen or hydrogen at 100 to 300° C. for 2 to 180 minutes, with the first thermal treatment at 150 to 250° C. for 5 to 120 minutes being more preferred.

In the present invention, one cycle of the first thermal treatment includes for example, heating the phosphor layer 14 to 100° C. or higher, then cooling it to 50° C. or lower.

In the first embodiment of the production process of the present invention, the first thermal treatment is performed once or more, but the conditions in each cycle may be the same or different. In addition, the phosphor layer 14 may be polished between the cycles in the first thermal treatment or before the second thermal treatment.

As described above, the second thermal treatment is a thermal treatment performed in the presence of oxygen for 5 to 180 minutes at a temperature that is equal to or higher than the ultimate temperature of the phosphor layer in the subsequent steps and falls within the range of 150 to 250° C.

The second thermal treatment performed in the absence of oxygen cannot remove the liberated element. The oxygen partial pressure in the atmosphere in which the second thermal treatment is performed is not particularly limited but is preferably 5 to 30%, more preferably 15 to 25%, and the second thermal treatment is most preferably performed in the air.

The second thermal treatment is not sufficiently effective at a temperature that is less than the ultimate temperature of the phosphor layer in the subsequent steps or less than 150° C., thus causing an inconvenience such as insufficient removal of liberated gaseous halogen. When the phosphor layer 14 is made up of a stimulable phosphor, it is necessary, as described above, to significantly reduce the amount of activator in order to adjust the yellow density to less than 0.001 under the conditions defined above, which may cause a practical problem.

On the other hand, a temperature in excess of 250° C. in the second thermal treatment may readily cause overheating, leading to such an inconvenience as lowered sensitivity.

The second thermal treatment is also not sufficiently effective at a treatment time of less than 5 minutes, thus causing an inconvenience such as insufficient removal of liberated gaseous halogen. When the phosphor layer 14 is made up of a stimulable phosphor, it is necessary to significantly reduce the amount of activator as in the case where the temperature condition is not met, which may cause a practical problem.

On the other hand, a treatment time in excess of 180 minutes in the second thermal treatment may cause such inconveniences as lowered sensitivity and unnecessarily prolonged operation.

In the first embodiment of the production process of the present invention, it is preferable to humidify the phosphor layer 14 (to make it absorb moisture) prior to at least one cycle of the first thermal treatment and optionally prior to the second thermal treatment.

There is no particular limitation on the conditions of the humidification. More specifically, the humidification may be performed before heating or during cooling following such heating, by allowing the phosphor layer 14 (the substrate 12 hating the phosphor layer 14 formed thereon) to stand for a certain period of time in a room where the atmosphere is not particularly controlled to make it absorb the moisture in the atmosphere. Alternatively, the humidification may be performed by allowing the phosphor layer to stand in the same manner in an appropriately humidified and optionally heated environment.

The same humidification as in the second embodiment of the production process of the present invention to be described later is preferably performed. The humidification will be described below in further detail.

In the case where the humidification is performed a plurality of times in the first embodiment of the production process of the present invention, the conditions of each humidification step may be the same or different.

On the other hand, in the second embodiment of the production process of the present invention, the phosphor layer 14 is formed as described above, which is followed by the humidification in which moisture is absorbed into the phosphor layer 14 such that the humidified phosphor layer 14 has a weight of 100.02 to 100.85 relative to the weight of the phosphor layer 14 before the humidification taken as 100. The humidification is followed by the thermal treatment, which in turn is followed by entirely sealing the phosphor layer 14 with the protective layer 20.

In other words, the humidification is a treatment in which moisture is absorbed into the phosphor layer 14 such that the equation: [(moisture+phosphor layer)/phosphor layer]×100=100.02 to 100.85 is met. In other words, the humidification is a treatment in which 0.02 to 0.85 wt % of moisture is absorbed into the phosphor layer 14.

The weight of the humidified phosphor layer 14 relative to the weight of the phosphor layer 14 before the humidification taken as 100 may be determined by, for example, the formula:

(c−a)/(b−a)×100

where “a” is the weight (g) of the substrate before vapor deposition; “b” is the total (g) of the weights of the substrate and phosphor layer after vapor deposition; and “c” is the total (g) of the weights of the substrate and moisture-containing phosphor layer after humidification.

The inventors of the present invention have made intensive studies to obtain the conversion panel 10 with excellent sensitivity and as a result found that the phosphor layer 14 that has absorbed a certain amount of moisture is then subjected to a thermal treatment to enable the sensitivity of the phosphor layer 14 to be improved while promoting the removal of the element such as bromine liberated from the phosphor due to the thermal treatment.

When the weight of the phosphor layer 14 including the weight of moisture absorbed into the phosphor layer 14 by the humidification is less than 100.02 relative to the weight of the phosphor layer 14 before the humidification taken as 100, the humidification is not sufficiently effective to improve the sensitivity of the phosphor layer 14 and to remove the liberated element in the subsequent thermal treatment. When the phosphor layer 14 is made up of a stimulable phosphor, it is necessary to significantly reduce the amount of activator as in the above-mentioned second thermal treatment in order to adjust the yellow density to less than 0.001 under the conditions defined above, which may cause a practical problem.

On the other hand, when the weight of the phosphor layer 14 including the weight of moisture absorbed into the phosphor layer 14 by the humidification exceeds 100.85 relative to the weight of the phosphor layer 14 before the humidification taken as 100, the amount of moisture absorbed is increased so much that the columnar crystals constituting the phosphor layer 14 may deliquesce to cause the columnar crystals to stick together or collapse and the phosphor layer 14 to come off, whereby the conversion panel 10 obtained cannot be proper.

In the embodiment under consideration, the weight of the phosphor layer 14 including the weight of moisture absorbed into the phosphor layer 14 by the humidification is preferably 100.02 to 100.85 and more preferably 100.4 to 100.7 relative to the weight of the phosphor layer 14 before the humidification taken as 100.

There is no particular limitation on the conditions of the humidification as long as moisture of the weight defined above can be absorbed into the phosphor layer 14.

The following three types of humidification are preferable.

The humidity of the environment where the humidification is performed greatly affects the amount of moisture absorbed into the phosphor layer 14 by the humidification. In the case where the environment where the humidification is performed has a relative humidity of up to 45% RH, deliquescence and sticking in the phosphor layer 14 may hardly occur, but on the other hand, the efficiency of the moisture absorption in the phosphor layer 14 is low.

A first type of humidification that may be preferably used includes humidifying the phosphor layer 14 for 0.5 to 168 hours in an environment of a temperature of 10 to 60° C. and a relative humidity of 20 to 45% RH (exposing the phosphor layer 14 to the humidification in the environment defined above for 0.5 to 168 hours).

The humidification in the above environment for a period of less than 0.5 hour is highly unlikely to achieve sufficient absorption of moisture into the phosphor layer 14. On the other hand, the humidification in the above environment for a period exceeding 168 hours may cause excessive absorption of moisture into the phosphor layer 14 to increase the weight of moisture absorbed by the humidification to 0.0085 or more relative to the weight of the phosphor layer 14, which is also disadvantageous from various viewpoints such as working efficiency.

The humidification in the above environment is preferably performed for 1 to 72 hours, which will offer more appropriately improved sensitivity and satisfactory workability.

When the humidification is performed in the environment having a relative humidity in excess of 45% RH, absorption of moisture into the phosphor layer 14 and deliquescence of columnar crystals may readily occur. To what extent the sensitivity is improved by the humidification depends on the relative humidity, and the sticking of the columnar crystals depends on the absolute humidity multiplied by the treatment time. Therefore, the humidification is defined within the range of the product of the absolute humidity and the treatment time as denoted by “X” to enable the sensitivity to be advantageously increased while advantageously preventing the deterioration of the phosphor layer 14 due to moisture absorption.

Therefore, a second type of humidification that may be preferably used includes humidifying the phosphor layer for a predetermined period of time in an environment of a temperature T of 10 to 60° C. and a relative humidity H satisfying “45% RH<H≦80% RH” so that “X” represented by the following formula:

X=exp(6.4×10⁻²×(T+273))×H×10⁻¹⁰×t

(where t (h) is the treatment time) takes a value of 0.2 to 210.

When “X” takes a value of less than 0.2, the phosphor layer 14 may not sufficiently absorb moisture, whereas when “X” takes a value in excess of 210, the phosphor layer 14 absorbs so much moisture that the weight of moisture absorbed by the humidification may exceed 0.0085 relative to the weight of the phosphor layer 14.

“X” preferably takes a value of 0.3 to 40 and more preferably 0.6 to 14, because within such range, the sensitivity can be more advantageously improved while offering satisfactory workability.

In addition, when the humidification is performed in the environment having a relative humidity in excess of 80% RH, the phosphor layer 14 quite readily absorbs moisture. Therefore, a third type of humidification that may be preferably used includes humidifying the phosphor layer for 10 to 30 minutes (0.166 to 0.5 hour) in an environment of a temperature of 10 to 60° C. and a relative humidity in excess of 80% RH but less than 90% RH.

At a humidification period of less than 10 minutes, the phosphor layer 14 may not sufficiently absorb moisture, whereas when the humidification is performed in the environment defined above for a period in excess of 30 minutes, the phosphor layer 14 absorbs so much moisture that the weight of moisture absorbed by the humidification may exceed 0.0085 relative to the weight of the phosphor layer 14.

The humidification is performed at a temperature of 10 to 60° C. in all of the three types of humidification.

At a humidification temperature of less than 10° C., condensation forms on the phosphor layer 14 when it is introduced in or taken out of the device (environment) for humidification, which may cause such inconveniences as deliquescence and sticking of the columnar crystals.

On the other hand, a temperature in excess of 60° C. causes an increase in the absolute humidity and an excessive increase in the amount of moisture absorbed into the phosphor layer 14, which may cause such inconveniences as deliquescence and sticking of the columnar crystals for an extremely short period of time.

In the second embodiment of the production process of the present invention, such humidification is followed by the thermal treatment for heating the phosphor layer 14.

There is no particular limitation on the conditions of the thermal treatment and the thermal treatment is preferably performed in an inert atmosphere such as a nitrogen atmosphere or in the presence of a small amount of oxygen or hydrogen at 100 to 300° C. for 2 to 180 minutes, and more preferably at 150 to 250° C. for 5 to 120 minutes.

After one or more cycles of the first thermal treatment and one cycle of the second thermal treatment have been finished in the first embodiment of the production process of the present invention, or after the humidification and the thermal treatment as described above have been finished in the second embodiment, the phosphor layer 14 is entirely covered with the protective layer 20 to hermetically seal it.

A sticky cleaner or ionic wind may be used to clean the surface of the phosphor layer 14 prior to sealing the phosphor layer 14 with the protective layer 20.

There is no particular limitation on the method of sealing the phosphor layer 14 with the protective layer 20, but any known method for sealing a plate with a sheet may be used.

An exemplary method is as follows: The adhesive layer 18 is formed on the perimeter of the protective layer 20 or the region of the substrate 12 surrounding the phosphor layer 14 to entirely cover the phosphor layer 14 with the protective layer 20; then, the protective layer 20 is pressed by a pressing member such as a roller to adhere the protective layer 20 to the substrate 12 on the whole periphery of the phosphor layer 14 to hermetically sealing the whole phosphor layer 14 with the substrate 12 and the protective layer 20. The adhesive layer 18 is preferably formed on the whole surface of the protective layer 20 or the surface of the phosphor layer 14 as well so that the protective layer 20 is also adhered to the phosphor layer 14 as shown in the FIGURE.

When a thermoplastic resin is used for the adhesive layer 18, thermocompression bonding (heat lamination) in which the protective layer 20 is pressed by a pressing member such as a roller while heating the phosphor layer 14 and/or the pressing member is preferably used prior to sealing.

Another sealing method may be used in which the surface of the substrate 12 is provided with a frame (e.g., a frame in the shape of a hollow quadrangular prism) surrounding the phosphor layer 14 (in other words, the phosphor layer is formed within the frame), and the protective layer 20 is adhered via the adhesive layer 18 to the upper surface of the frame and optionally the phosphor layer 14 to hermetically seal the whole of the phosphor layer 14 with the substrate 12, the frame and the protective layer 20.

While the radiation image conversion panel and the process for producing the radiation image conversion panel according to the present invention have been described above in detail, the present invention is by no means limited to the foregoing embodiments and it should be understood that various improvements and modifications can of course be made without departing from the scope and spirit of the invention.

### EXAMPLES

On the following pages, the present invention is described in greater detail with reference to specific examples. It should of course be understood that the present invention is by no means limited to the following examples.

### Example 1-1

Using europium bromide and cesium bromide as film-forming materials for the activator and the phosphor, respectively, two-source vacuum evaporation was carried out to prepare a conversion panel of the type shown in the FIGURE which is generally indicated by 10 and has a phosphor layer 14.

An aluminum plate having an area of 450×450 mm (thickness: 10 mm) was prepared.

The substrate 12 was set on a substrate holder in a vacuum evaporation apparatus; in addition, the respective film-forming materials were set in specified positions and the surface of the substrate 12 was masked such that a film would be deposited in the center area of the substrate 12 measuring 430×430 nm. The substrate holder was equipped with a heater that heats the substrate from its back surface (surface on which the phosphor layer was not to be formed).

The film-forming materials were heated in a resistance heating apparatus using tantalum crucibles and a DC source capable of outputting a power of 6 kW. Installed above the crucibles was a shutter for shielding the substrate against the film-forming materials having evaporated therefrom. The crucible accommodating the film-forming material for the phosphor was furnished with a temperature measuring means.

After setting the substrate on its holder, the vacuum chamber was closed and switched on to perform evacuation using a diffusion pump and a cryogenic coil. The shutter was in the closed state.

When the degree of vacuum had reached 8×10⁻⁴ Pa, argon gas was introduced into the vacuum chamber to adjust the degree of vacuum to 2.6 Pa; then, the DC source was driven so that an electric current was applied to the crucibles to melt the film-forming materials they contained. Cesium bromide was melted at 670° C. As for europium bromide, the power was raised until its melting temperature was reached and a complete melt of europium bromide was formed; thereafter, the power input was reduced until the temperature was not high enough for the europium bromide to evaporate. The power to be delivered for melting the europium bromide was controlled in accordance with a preliminary experiment for its melting.

At the point in time when 60 minutes had passed since the start of melting the film-forming materials, the shutter above the crucibles loaded with cesium bromide was opened so that the formation of the phosphor layer 14 (matrix region) on the surface of the substrate 12 by vapor deposition started (cesium bromide was vaporized at the temperature of 670° C.).

As soon as the shutter was opened, the substrate 12 was heated to 160° C. with the heater. The power to be applied to the crucibles was adjusted such that the deposition rate of cesium bromide onto the substrate 12 could reach 10 μm/min.

When the layer thickness reached 50 μm, the shutter was closed and the supply of argon gas was so adjusted that the pressure (Ar gas pressure) in the vacuum chamber would be 0.8 Pa; at the same time, the power to europium bromide (or its crucibles) was raised to the level at which the molarity ratio of Eu/Cs in the phosphor layer checked in advance would be 0.001:1.

The shutter above the crucibles loaded with cesium bromide and europium bromide was opened to resume the formation of the phosphor layer 14 (start the vapor deposition of the stimulable phosphor).

When the thickness of the phosphor layer 14 reached 700 μm, the DC source was switched off to stop the application of an electric current to the crucibles to end the formation of the phosphor layer 14.

Subsequently, dry air was introduced into the vacuum chamber until the internal pressure became atmospheric. The vacuum chamber was opened to the atmosphere and the substrate 12 having the phosphor layer 14 formed thereon (hereinafter referred to simply as the “substrate 12” unless particularly necessary) was taken out of the vacuum chamber and left to cool until the phosphor layer 14 reached room temperature.

Then, five cycles of the first thermal treatment which included heating the substrate 12 in a nitrogen atmosphere at 200° C. for 15 minutes and cooling it (allowing it to cool) to room temperature were repeatedly performed.

Then, one cycle of the second thermal treatment which included heating the substrate 12 in the air at 150° C. for 30 minutes (i.e., the last cycle of the repeatedly performed thermal treatment) was performed.

A thermal treatment unit used was in an ambient environment of a temperature of 20° C. and a humidity of 25% RH.

A (transparent and colorless) film was prepared for the protective layer 20. The film was formed by the method which included laminating a polyethylene terephthalate (PET) film (protective layer with a thickness of 6 μm; Lumirror manufactured by Toray Industries, Inc.) onto a heat-resistant, removable film (thickness: about 51 μm; CT50 manufactured by PANAC Corporation); forming a SiO₂ sub-layer (thickness: 100 nm) on a surface of the PET film by sputtering; forming a hybrid sub-layer of SiO₂ and polyvinyl alcohol (PVA) (weight ratio of SiO₂ to PVA of 1:1, thickness; 600 nm) on the SiO₂ sub-layer by a sol-gel process; and forming another SiO₂ sub-layer (thickness; 100 nm) on the hybrid sub-layer by sputtering.

A polyester resin (VYLON 300 manufactured by Toyobo Co., Ltd.) was added to methyl ethyl ketone and mixed to produce a coating solution for adhesive layer. The thus produced coating solution was applied to the entire surface of the SiO₂ sub-layer of the film to form the adhesive layer 18.

The protective layer 20 was laminated onto the substrate 12 having the phosphor layer 14 formed thereon so that the adhesive layer 18 faces the phosphor layer 14, thus covering the whole surface of the phosphor layer 14 with the protective layer 20; the protective layer 20 was pressed by a roller heated to 140° C. against the substrate 12 to adhere the protective layer 20 to the phosphor layer 14 and the substrate 12 by fusion bonding to thereby sealing the whole surface of the phosphor layer 14 with the protective layer 20; the removable film was removed and the laminate film remaining on the phosphor layer 14 was fusion-bonded again in the same manner as above to produce the conversion panel 10.

The treatment temperature (° C.), treatment time (min) and treatment atmosphere in the second thermal treatment of the conversion panel 10 are shown in Table 1 below.

### Examples 1-2 to 1-7 and Comparative Examples 1-1 to 1-7

Example 1-1 was repeated except that the conditions shown in Table 1 were used for the treatment temperature (° C.), treatment time (min) and treatment atmosphere in the second thermal treatment, thereby producing the conversion panels 10.

### Comparative Example 1-8

Example 1-1 was repeated except that the power to be delivered to europium bromide (crucibles containing it) for vapor deposition of the stimulable phosphor was adjusted such that the molarity ratio of Eu/Cs in the phosphor layer 14 checked in advance would be 1×10⁻⁶:1, thereby producing the conversion panel 10.

### Comparative Example 1-9

Example 1-1 was repeated except that the first thermal treatment was performed once and the second thermal treatment was not performed, thereby producing the conversion panel 10.

The thus produced conversion panels in Examples 1-1 to 1-7 and Comparative Examples 1-1 to 1-9 were evaluated for their sensitivity (sensitivity to PSL or amount of PSL) and measured for the color density at the plane of incidence of exciting light (at the surface of the protective layer 20).

The measurement methods applied are as described below.

### (Sensitivity)

Each of the conversion panels 10 was placed in a cassette shielded from light and exposed to about 1 mR of X-rays at a tube voltage of 80 kVp.

After the exposure to X-rays, the conversion panel 10 was taken out of the cassette in the dark and excited with semiconductor laser light (wavelength, 660 nm; 10 mV). The photostimulated luminescence emitted from the phosphor layer was measured with a photomultiplier tube after it was separated from the exciting light by passage through an exciting light cutoff filter (B410 manufactured by HOYA CORPORATION).

The sensitivity was evaluated relative to the sensitivity in Comparative Example 1-9 taken as 100.

### (Color Density)

A spectrophotometer (including an integrating sphere set in the model 3300 manufactured by Hitachi High-Technologies Corporation) was used to measure the reflectance (specular reflectance+reflectance) of light with a wavelength of 440 nm from the conversion panel, and the thus measured reflectance was substituted into the Kubelka-Munk equation to calculate the density of the color corresponding to the wavelength of 440 nm.

The measurement results of the sensitivity and color density in each conversion panel are also shown in Table 1.

TABLE 1

| | Second thermal treatment | | | Performance | |
|---|---|---|---|---|---|
| | Treatment | Treatment | Treatment | Sen- | Color |
| | temperature | time | atmosphere | sitivity | density |
| Example 1-1 | 150 | 30 | Air | 136 | 0.095 |
| Example 1-2 | 160 | 30 | Air | 138 | 0.076 |
| Example 1-3 | 180 | 30 | Air | 139 | 0.069 |
| Example 1-4 | 200 | 30 | Air | 141 | 0.052 |
| Example 1-5 | 250 | 30 | Air | 137 | 0.051 |
| Example 1-6 | 200 | 60 | Air | 136 | 0.058 |
| Example 1-7 | 200 | 180 | Air | 134 | 0.052 |
| Comparative | None | | | 133 | 0.100 |
| Example 1-1 | | | | | |
| Comparative | 130 | 30 | Air | 130 | 0.101 |
| Example 1-2 | | | | | |
| Comparative | 260 | 30 | Air | 125 | 0.097 |
| Example 1-3 | | | | | |
| Comparative | 200 | 3 | Air | 132 | 0.102 |
| Example 1-4 | | | | | |
| Comparative | 200 | 200 | Air | 120 | 0.096 |
| Example 1-5 | | | | | |
| Comparative | 200 | 30 | Vacuum | 131 | 0.101 |
| Example 1-6 | | | (10 Pa) | | |
| Comparative | 200 | 30 | Nitrogen | 132 | 0.102 |
| Example 1-7 | | | | | |
| Comparative | 200 | 30 | Air | 75 | 0.0004 |
| Example 1-8 | | | | | |

| | | | |
|---|---|---|---|
| Comparative | None | 100 | 0.098 |
| Example 1-9 | | | |

In Comparative Example 1-9 carried out for the criterion of sensitivity, the first thermal treatment was carried out only once.

As is seen from Table 1, the conversion panels of the present invention in which the first thermal treatment was performed a plurality of times and was followed by the second thermal treatment in a oxygen-containing atmosphere under predetermined conditions have more excellent characteristics such as less coloration at the plane of incidence of exciting light and much higher sensitivity than the conventional conversion panels in which the second thermal treatment was not performed and the conversion panels in which the second thermal treatment was performed under improper conditions Comparative Example 1-8 achieves a very low color density but the amount of activator used is too small to achieve high enough sensitivity for practical use.

### Example 2-1

The same substrate 12 as used in Example 1-1 was treated in the same manner as in Example 1-1 to form the phosphor layer 14 of CsBr:Eu thereon. Dry air was introduced into the vacuum chamber until the internal pressure became atmospheric and the vacuum chamber was opened to the atmosphere. The substrate 12 having the phosphor layer 14 formed thereon (hereinafter referred to simply as the “substrate 12” as above unless particularly necessary) was taken out of the vacuum chamber and left to cool until the phosphor layer 14 reached room temperature.

Then, the substrate 12 was left to stand for 24 hours in an environment of a temperature of 20° C. and a relative humidity of 35% RH to humidify the phosphor layer 14. Under these conditions, “X” was 11.76.

The weight of the humidified phosphor layer 14 relative to the weight of the phosphor layer 14 before the humidification taken as 100 (i.e., [H₂O+CsBr:Eu]/CsBr:Eu)×100) was 100.2. The weights of the phosphor layer 14 before and after the humidification were measured by using the weight of the substrate 12 previously measured before the phosphor layer 14 was formed thereon.

After the end of the humidification, the substrate 12 was heated at 200° C. for 15 minutes in a nitrogen atmosphere to heat-treat the phosphor layer 14.

The whole surface of the phosphor layer 14 on the substrate 12 having undergone the thermal treatment was sealed with the protective layer 20 in the same manner as in Example 1-1 to produce the conversion panel 10.

The conditions of the humidification (temperature (° C.), relative humidity (% RH) and time (h)), “X” in the humidification, and the weight of the humidified phosphor layer 14 relative to the weight of the phosphor layer 14 before the humidification taken as 100 (weight increase) are shown in Table 2 below.

### Examples 2-2 to 2-28 and Comparative Examples 2-1 to 2-9

Example 2-1 was repeated except that the conditions shown in Table 2 were used for the humidification temperature (° C.), the relative humidity (% RH) in the treatment environment, and the treatment time (h), thereby producing the conversion panels 10.

The thus produced conversion panels in Examples 2-1 to 2-28 and Comparative Examples 2-1 to 2-9 were evaluated for their sensitivity (sensitivity to PSL or amount of PSL), state of the phosphor layer 14 and delamination of the phosphor layer 14, and measured for the color density at the plane of incidence of exciting light (at the surface of the protective layer 20).

The measurement methods applied are as described below.

### (Sensitivity)

The sensitivity of the conversion panels was measured in the same manner as in Example 1-1. The sensitivity was evaluated relative to the PSL sensitivity in Comparative Example 2-1 taken as 100.

### (Delamination of the Phosphor Layer)

The state of the phosphor layer 14 was visually observed.

As a result, a sample was rated as “Excellent” when the phosphor layer did not come off, and as “Poor” when the phosphor layer came off so that the sensitivity and color density could not be measured.

### (Color Density)

The density of the color corresponding to the wavelength of 440 nm at the plate of incidence of exciting light (at the surface of the protective layer 20) was measured in the same manner as in Example 1-1.

The measurement results are also shown in Table 2.

TABLE 2

| | | | | | | Performance | | |
|---|---|---|---|---|---|---|---|---|
| | Humidification condition | | | | Weight | | | Color |
| | Temperature | Humidity | Time | X | increse | Sensitivity | Delamination | density |
| EX 2-1 | 20 | 35 | 24 | 11.76 | 100.02 | 142 | Excellent | 0.061 |
| EX 2-2 | 20 | 35 | 168 | 82.32 | 100.04 | 146 | Excellent | 0.057 |
| EX 2-3 | 20 | 45 | 0.5 | 0.28 | 100.01 | 136 | Excellent | 0.068 |
| EX 2-4 | 20 | 45 | 24 | 13.44 | 100.44 | 185 | Excellent | 0.036 |
| EX 2-5 | 20 | 45 | 72 | 40.32 | 100.62 | 189 | Excellent | 0.031 |
| EX 2-6 | 20 | 45 | 168 | 94.08 | 100.64 | 208 | Excellent | 0.029 |
| EX 2-7 | 30 | 45 | 72 | 85.68 | 100.58 | 204 | Excellent | 0.024 |
| EX 2-8 | 30 | 45 | 168 | 199.92 | 100.59 | 188 | Excellent | 0.041 |
| EX 2-9 | 40 | 45 | 168 | 378 | 100.61 | 195 | Excellent | 0.030 |
| EX 2-10 | 55 | 45 | 168 | 982.8 | 100.62 | 200 | Excellent | 0.029 |
| EX 2-11 | 15 | 45 | 168 | 77.28 | 100.60 | 199 | Excellent | 0.026 |
| EX 2-12 | 15 | 50 | 0.5 | 0.255 | 100.04 | 162 | Excellent | 0.045 |
| EX 2-13 | 15 | 50 | 24 | 12.24 | 100.31 | 178 | Excellent | 0.038 |
| EX 2-14 | 15 | 50 | 72 | 36.7 | 100.52 | 201 | Excellent | 0.024 |
| EX 2-15 | 30 | 60 | 0.5 | 0.79 | 100.07 | 156 | Excellent | 0.056 |
| EX 2-16 | 30 | 60 | 24 | 37.92 | 100.62 | 205 | Excellent | 0.022 |
| EX 2-17 | 30 | 60 | 72 | 113.76 | 100.67 | 204 | Excellent | 0.025 |
| EX 2-18 | 30 | 80 | 0.5 | 1.055 | 100.10 | 175 | Excellent | 0.035 |
| EX 2-19 | 30 | 80 | 24 | 152.15 | 100.61 | 200 | Excellent | 0.020 |
| EX 2-20 | 35 | 80 | 24 | 69.84 | 100.59 | 199 | Excellent | 0.030 |
| EX 2-21 | 35 | 80 | 72 | 209.52 | 100.75 | 187 | Excellent | 0.040 |
| EX 2-22 | 40 | 55 | 72 | 198.37 | 100.66 | 202 | Excellent | 0.026 |
| EX 2-23 | 40 | 60 | 48 | 144.48 | 100.80 | 203 | Excellent | 0.022 |
| EX 2-24 | 15 | 85 | 0.2 | 0.17 | 100.24 | 175 | Excellent | 0.042 |
| EX 2-25 | 15 | 85 | 0.5 | 0.43 | 100.46 | 178 | Excellent | 0.046 |
| EX 2-26 | 40 | 85 | 0.2 | 0.852 | 100.37 | 185 | Excellent | 0.039 |
| EX 2-27 | 50 | 85 | 0.2 | 1.616 | 100.30 | 158 | Excellent | 0.043 |
| EX 2-28 | 50 | 85 | 0.4 | 3.232 | 100.51 | 171 | Excellent | 0.049 |
| CE 2-1 | 20 | 25 | 1 | 0.35 | 100.00 | 100 | Excellent | 0.098 |
| CE 2-2 | 20 | 35 | 0.2 | 0.098 | 100.00 | 101 | Excellent | 0.100 |
| CE 2-3 | 55 | 45 | 0.2 | 0.96 | 100.00 | 100 | Excellent | 0.103 |
| CE 2-4 | 30 | 60 | 168 | 265.44 | 100.89 | — | Poor | — |
| CE 2-5 | 35 | 80 | 84 | 244.44 | 101.01 | — | Poor | — |
| CE 2-6 | 40 | 55 | 84 | 231.84 | 100.94 | — | Poor | — |
| CE 2-7 | 40 | 60 | 72 | 216.72 | 101.09 | — | Poor | — |
| CE 2-8 | 15 | 85 | 1 | 0.86 | 101.61 | — | Poor | — |
| CE 2-9 | 50 | 85 | 1 | 8.08 | 101.59 | — | Poor | — |

As is seen from Table 2, the conversion panels of the present invention in which the humidification was carried out so that the humidified phosphor layer had a weight of 100.2 to 100.85 relative to the weight of the phosphor layer before the humidification taken as 100, and then the thermal treatment was carried out, are high-quality conversion panels with high sensitivity in which deliquescence, melting and delamination of the phosphor layer 14 were found not to occur.

On the other hand, in Comparative Examples 2-1 to 2-3 in which the amount of moisture absorbed by the humidification was small, high sensitivity could not be achieved, and in Comparative Examples 2-4 to 2-9 in which moisture was excessively absorbed by the humidification, the phosphor layer came off so that the measurement of the sensitivity and color density and hence the practical use of the panels were impossible.

### Example 3

The same substrate 12 as used in Example 1-1 was treated in the same manner as in Example 1-1 to form the phosphor layer 14 of CsBr:Eu thereon. Dry air wad introduced into the vacuum chamber until the internal pressure became atmospheric and the vacuum chamber was opened to the atmosphere. The substrate 12 having the phosphor layer 14 formed thereon (hereinafter referred to simply as the “substrate 12” as above unless particularly necessary) was taken out of the vacuum chamber and left to cool until the phosphor layer 14 reached room temperature.

Then, the substrate 12 was left to stand for 168 hours in an environment of a temperature of 20° C. and a relative humidity of 45% RH to humidify the phosphor layer 14. Under these conditions, “X” was 94.08.

The weight of the humidified phosphor layer 14, relative to the weight of the phosphor layer 14 before the humidification taken as 100 (i.e., [H₂O+CSBr:Eu)/CsBr:Eu]×100) was 100.64. The weights of the phosphor layer 14 before and after the humidification were measured as in Example 2-1.

After the end of the humidification, the phosphor layer 14 was subjected to only one cycle of the first thermal treatment which included heating the substrate 12 in a nitrogen atmosphere at 200° C. for 15 minutes.

The phosphor layer having undergone the first thermal treatment was then subjected to the second thermal treatment (the last cycle of the repeatedly performed thermal treatment) which included heating the substrate 12 in the air at 200° C. for 30 minutes.

The whole surface of the phosphor layer 14 on the substrate 12 having undergone the thermal treatment was sealed with the protective layer 20 in the same manner as in Example 1-1 to produce the conversion panel 10.

The thus obtained conversion panel 10 was evaluated as in example 2-1 for the sensitivity, delamination and color density (in other words, the sensitivity and color density were evaluated as in Example 1-1).

As a result, Example 3 in which the first and second thermal treatments had been properly performed achieved highly excellent characteristics such as a sensitivity of 212 relative to Comparative Example 2-1 taken as 100, no delamination, and a color density of 0.019.

From the foregoing results, the effects of the present invention are apparent.

What is claimed is:

1. A radiation image conversion panel comprising:
a substrate;
a phosphor layer which is formed on said substrate by vapor-phase deposition; and
a protective layer which entirely covers said phosphor layer to hermetically seal said phosphor layer,
wherein a color at a surface of said radiation image conversion panel on which exciting light is incident has a density of 0.001 to 0095, and
said color is a color corresponding to a wavelength of 440 nm.

2. The radiation image conversion panel according to claim 1, wherein said phosphor layer comprises columnar crystals.

3. The radiation image conversion panel according to claim 1, wherein said phosphor layer comprises a stimulable phosphor represented by general formula “CsBr:Eu”.

4. The radiation image conversion panel according to claim 1, wherein said protective layer includes:
a polyethylene terephthalate film;
a first SiO₂ sub-layer formed on said polyethylene terephthalate film;
a hybrid sub-layer of SiO₂ and polyvinyl alcohol formed on said first SiO₂ sub-layer; and
a second SiO₂ sub-layer formed on said hybrid sub-layer.

5. A process for producing a radiation image conversion panel comprising the steps of:
forming a phosphor layer on a surface of a substrate by vapor-phase deposition;
subjecting said phosphor layer to one or more cycles of a first thermal treatment which comprises heating said phosphor layer under predetermined conditions and cooling said heated phosphor layer; and
subjecting said phosphor layer having undergone said one or more cycles of the first thermal treatment to only one cycle of a second thermal treatment which comprises heating said phosphor layer in a presence of oxygen for 5 to 180 minutes at a temperature that is equal to or higher than an ultimate temperature of said phosphor layer in subsequent steps and falls within a range of 150 to 250° C.

6. The process according to claim 5, further comprising a step of performing humidification for making said phosphor layer absorb moisture on said phosphor layer prior to at least one cycle of said one or more cycles of said first thermal treatment.

7. The process according to claim 6, wherein said humidification is a treatment for making said phosphor layer absorb the moisture such that said phosphor layer after said humidification has a weight of 100.02 to 100.85 relative to a weight of said phosphor layer before said humidification taken as 100.

8. The process according to claim 6, wherein said humidification for making said phosphor layer absorb the moisture is further performed after said first thermal treatment and prior to said second thermal treatment.

9. The process according to claim 8, wherein said humidification is a treatment for making said phosphor layer absorb the moisture such that said phosphor layer after said humidification has a weight of 100.02 to 100.85 relative to a weight of said phosphor layer before said humidification taken as 100.

10. The process according to claim 5, further comprising a step of covering entirely said phosphor layer with a protective layer to hermetically seal said phosphor layer after said second thermal treatment.

11. The process according to claim 10, wherein said protective layer includes:
a polyethylene terephthalate film;
a first SiO₂ sub-layer formed on said polyethylene terephthalate film;
a hybrid sub-layer of SiO₂ and polyvinyl alcohol formed on said first SiO₂ sub-layer; and
a second SiO₂ sub-layer formed on said hybrid sub-layer.

12. A process for producing a radiation image conversion panel comprising the steps of:
forming a phosphor layer on a surface of a substrate by vapor-phase deposition;
subjecting said phosphor layer to humidification which is a treatment for making said phosphor layer absorb moisture such that said phosphor layer after the humidification has a weight of 100.02 to 100.85 relative to a weight of said phosphor layer before the humidification taken as 100; and
subjecting said phosphor layer to a thermal treatment for heating said phosphor layer.

13. The process according to claim 12, wherein said humidification is a treatment to expose said phosphor layer for 0.5 to 168 hours to an environment of a temperature of 10 to 60° C. and a relative humidity of 20 to 45% RH.

14. The process according to claim 12, wherein said humidification is a treatment to expose said phosphor layer for a predetermined period of time to an environment of a temperature T of 10 to 60° C. and a relative humidity H satisfying “45% RH<H≦80% RH” so that “X” represented by formula:
X=exp(6.4×10⁻²×(T+273))×H×10⁻¹⁰×t
(where t (h) is a treatment time) takes a value of 0.2 to 210.

15. The process according to claim 12, wherein said humidification is a treatment to expose said phosphor layer for 10 to 30 minutes to an environment of a temperature of 10 to 60° C. and a relative humidity in excess of 80% RH but less than 90% RH.

16. The process according to claim 12, further comprising a step of covering entirely said phosphor layer with a protective layer to hermetically seal said phosphor layer after said thermal treatment.

17. The process according to claim 16, wherein said protective layer includes:
a polyethylene terephthalate film;
a first SiO₂ sub-layer formed on said polyethylene terephthalate film;
a hybrid sub-layer of SiO₂ and polyvinyl alcohol formed on said first SiO₂ sub-layer, and
a second SiO₂ sub-layer formed on said hybrid sub-layer.
